(19) United States
(12) Patent Application Publication
(10) Pub. No.: US 2025/0273768 A1
(43) Pub. Date: Aug. 28, 2025

(54) SOLID-STATE BATTERY AND METHOD FOR PRODUCING THEREOF, AND BATTERY MODULE

(71) Applicant: TOYOTA JIDOSHA KABUSHIKI KAISHA, Toyota-shi (JP)

(72) Inventor: Kenichi KAKISHITA, Nagoya-shi (JP)

(73) Assignee: TOYOTA JIDOSHA KABUSHIKI KAISHA, Toyota-shi (JP)

(21) Appl. No.: 19/034,922

(22) Filed: Jan. 23, 2025

(30) Foreign Application Priority Data
Feb. 28, 2024 (JP) 2024-028789

(51) Int. Cl. H01M 10/658; H01M 10/0585

(52) U.S. Cl. CPC H01M 10/658; H01M 10/0585

(57) ABSTRACT

The present disclosure provides a solid-state battery that can effectively dissipate heat generated by the electrode stack. the solid-state battery 10 of the disclosure comprises an electrode stack 110. The electrode stack 110 has a first current collector layer 111, a first electrode active material layer 112, a solid electrolyte layer 113, a second electrode active material layer 114 and a second current collector layer 115, in that order. An insulating member 120 is disposed on at least part of the edge of the electrode stack 110. The second current collector layer 115 extends from the edge of the electrode stack 110 on which the insulating member 120 is disposed, and the second current collector layer 115 is contacted with the edge of the insulating member 120.

### FIELD

The present disclosure relates to a solid-state battery and a method for producing it, and to a battery module.

### BACKGROUND

Electric vehicles and hybrid vehicles are being developed with an increasing level of environmental awareness in the automobile industry, leading to demands for higher voltage secondary batteries. With the ongoing popularity and development of portable electronic devices as well, smaller and more lightweight high-capacity secondary batteries are needed that are able to continuously operate for longer periods of time.

As high-voltage and high-capacity batteries, batteries are known that comprise an electrode stack having a negative electrode collector layer, a negative electrode active material layer, a solid electrolyte layer, a positive electrode active material layer and a positive electrode collector layer, in that order.

With such a battery, if the current collector layer of one electrode extends from the electrode stack, for example, then it may come into contact with the current collector layer and/or active material layer of the other electrode, resulting in short circuiting. The part of a current collector layer extending from an electrode stack is referred to as a “collector tab”. Such short circuiting is particularly notable when the area of the current collector layer of one electrode is larger than the area of the current collector layer of the other electrode. Techniques have therefore been developed to prevent such short circuiting.

PTL 1, for example, discloses a method for producing a stacked all-solid-state battery, wherein the method comprises: preparing a first stack comprising a solid electrolyte layer, a first active material layer (electrode active material layer), a first current collector layer with a first collector tab extending to the side of the stacked all-solid-state battery, a first active material layer, and a solid electrolyte layer stacked in that order, coating the edge of the first stack with an insulator coating solution to form an insulation section (insulating member), stacking the first stack on which the insulation section is formed, a second active material layer, and a second current collector layer with a second collector tab extending to the side of the stacked all-solid-state battery, to prepare a battery structure (electrode stack) having a plurality of second laminated bodies each comprising a second current collector layer with a second collector tab, a second active material layer, a solid electrolyte layer, a first active material layer, a first current collector layer with a first collector tab, a first active material layer, a solid electrolyte layer, and a second active material layer, in that order, and joining a plurality of second collector tabs respectively extending from the plurality of second current collectors of the battery structure.

### CITATION LIST

### Patent Literature

PTL 1 Japanese Unexamined Patent Publication No. 2018-049696

### SUMMARY

### Technical Problem

In a battery comprising an electrode stack, the electrode stack may generate heat during charge-discharge, with the current collector layer of the electrode stack being particularly prone to high temperature. Because this heat generation may lower battery performance, it is desirable for the heat generated by the electrode stack to be effectively dissipated.

It is an object of the present disclosure to provide a solid-state battery that can effectively dissipate heat generated by the electrode stack and a method for producing thereof, and a battery module comprising the solid-state battery.

### Solution to Problem

The present inventors have found that the aforementioned object can be achieved by the following means.

### Aspect 1

A solid-state battery comprising an electrode stack, wherein:
the electrode stack has a first current collector layer, a first electrode active material layer, a solid electrolyte layer, a second electrode active material layer and a second current collector layer, in that order,
an insulating member is disposed on at least part of the edge of the electrode stack,
the second current collector layer extends from the edge of the electrode stack on which the insulating member is disposed, and
the second current collector layer is contacted with the insulating member.

### Aspect 2

The solid-state battery according to aspect 1, wherein:
the electrode stack has the first electrode active material layer, the solid electrolyte layer, the second electrode active material layer and the second current collector layer in that order on both sides of the first current collector layer, and
the one second current collector layer is contacted with the insulating member.

### Aspect 3

The solid-state battery according to aspect 2, wherein:
the insulating member is disposed at the edge of the electrode stack, from the one second electrode active material layer across to the other second electrode active material layer, and
the second current collector layer is contacted with the insulating member over 50% or more of the surface area of the insulating member.

### Aspect 4

The solid-state battery according to any one of aspects 1 to 3, wherein the insulating member includes a thermoplastic resin.

### Aspect 5

The solid-state battery according to any one of aspects 1 to 3, wherein the insulating member includes a mixture of a resin and an insulating filler, and the thermal conductivity of the insulating filler is greater than the thermal conductivity of the resin.

### Aspect 6

The solid-state battery according to aspect 5, wherein the insulating filler is a metal oxide.

### Aspect 7

The solid-state battery according to any one of aspects 1 to 6, wherein the first current collector layer is a negative electrode collector layer, the first electrode active material layer is a negative electrode active material layer, the second electrode active material layer is a positive electrode active material layer and the second current collector layer is a positive electrode collector layer.

### Aspect 8

A battery module comprising a solid-state battery according to any one of aspects 1 to 7.

### Aspect 9

A method for producing a solid-state battery according to any one of aspects 1 to 7, the method comprising the following steps:
(a) stacking the first current collector layer, the first electrode active material layer, the solid electrolyte layer and the second electrode active material layer in that order to form a preliminary stack,
(b) applying the insulating member onto at least part of the edge of the preliminary stack,
(c) stacking the second current collector layer on the second electrode active material layer of the preliminary stack after application of the insulating member, to form the electrode stack, and
(d) contacting the second current collector layer with the insulating member.

### Aspect 10

The method according to aspect 9, wherein:
the insulating member includes a thermoplastic resin, and
in step (d), the second current collector layer is bonded by being pressed against the insulating member while heating.

### Aspect 11

A solid-state battery comprising an electrode stack, wherein:
the electrode stack has a first current collector layer, a first electrode active material layer, a solid electrolyte layer, a second electrode active material layer and a second current collector layer, in that order,
an insulating member is disposed on at least part of the edge of the electrode stack,
the insulating member includes a mixture of a resin and an insulating filler, and
the thermal conductivity of the insulating filler is greater than the thermal conductivity of the resin.

### Advantageous Effects of Invention

According to the present disclosure it is possible to provide a solid-state battery that can effectively dissipate heat generated by the electrode stack and a method for producing thereof, and a battery module comprising the solid-state battery.

### BRIEF DESCRIPTION OF DRAWINGS

FIG. 1 is a schematic plan view showing an example of a solid-state battery of the disclosure.

FIG. 2 is a simplified cross-sectional view showing an example of a method of disposing an insulating member in a solid-state battery of the disclosure.

FIG. 3 is a simplified cross-sectional view showing an example of an insulating member including a mixture of a resin and an insulating filler in a solid-state battery of the disclosure.

FIG. 4 is a simplified perspective view showing an example of a battery module of the disclosure.

### DESCRIPTION OF EMBODIMENTS

An embodiment of the disclosure will now be described in detail with reference to the accompanying drawings. The disclosure is not limited to the embodiment described below, however, and various modifications may be implemented which do not depart from the gist thereof. The dimensional relationships in the drawings do not reflect actual dimensional relationships.

### Solid-State Battery

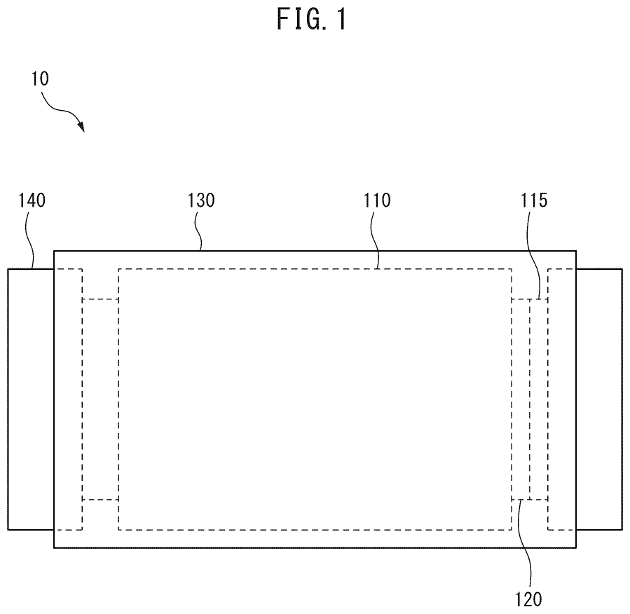

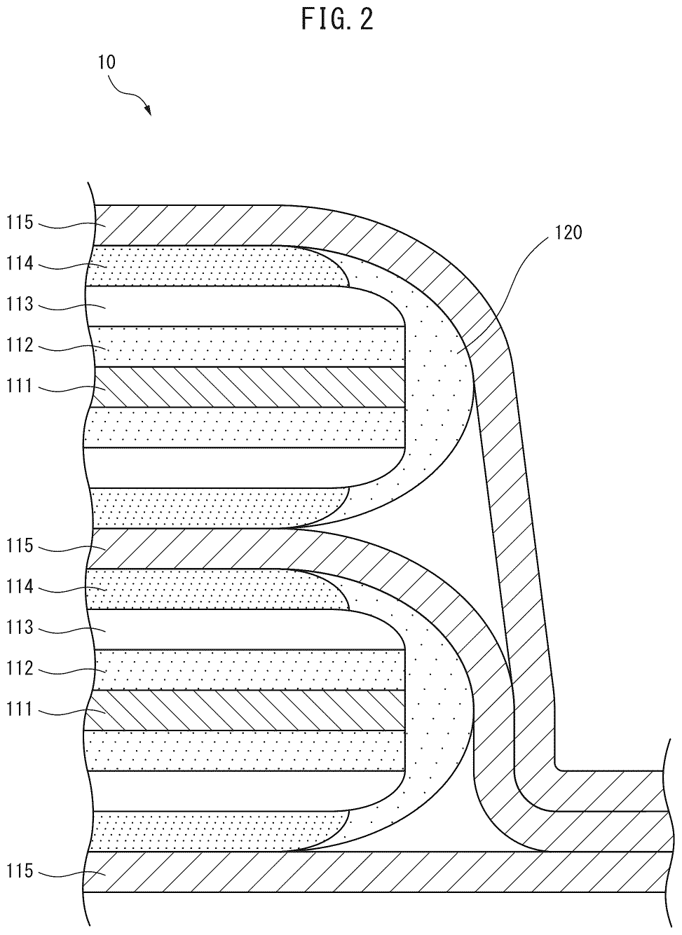

As exemplified in FIG. 1, the solid-state battery 10 of the disclosure comprises an electrode stack 110. As exemplified in FIG. 2, the electrode stack 110 has a first current collector layer 111, a first electrode active material layer 112, a solid electrolyte layer 113, a second electrode active material layer 114 and a second current collector layer 115, in that order. An insulating member 120 is disposed on at least part of the edge of the electrode stack 110. The second current collector layer 115 extends from the edge of the electrode stack 110 on which the insulating member 120 is disposed, and the second current collector layer 115 is contacted with the edge of the insulating member 120. FIG. 2 is a magnified simple cross-sectional view of part of the insulating member 120 of the solid-state battery 10 of the disclosure.

As mentioned above, in a battery comprising an electrode stack, the electrode stack may generate heat during charge-discharge, with the current collector layer of the electrode stack being particularly prone to high temperature. The present inventors found that if the second current collector layer extending from the edge of the electrode stack is contacted with the insulating member, then heat generated by the electrode stack can be more effectively dissipated, compared to when the electrode stack and the second current collector layer extending from the edge of the electrode stack are separated by air, for example.

When the insulating member is formed on the edge of the electrode stack, the collector tabs become separated from the electrode stack and mutually joined, by the amount of the portion where the insulating member is formed, resulting in lower volumetric efficiency of the battery. The present inventors have found that if the second current collector layer extending from the edge of the electrode stack is contacted with the insulating member, then the location where the collector tabs are mutually joined can be close to the electrode stack, thus helping to improve the volumetric efficiency of the battery.

According to the present disclosure, the second current collector layer, in particular, may be bonded to the insulating member. Such a construction allows the second current collector layer to be easily bonded by adhesion to the insulating member, for more effective dissipation of heat produced by the electrode stack. According to the disclosure, “adhesion” includes adhesion with a bonding agent, or pressure-sensitive adhesion with tape or a tacky material, or heat welding.

As exemplified in FIG. 2, when the electrode stack 110 has the first electrode active material layer 112, solid electrolyte layer 113, second electrode active material layer 114 and second current collector layer 115 in that order on both sides of the first current collector layer 111, the insulating member 120 may be disposed from one second electrode active material layer 114 across to the other second electrode active material layer 114, at the edge of the electrode stack 110, with the second current collector layer 115 contacting with the insulating member 120 over 50% or more of the surface area of the insulating member 120. With such a construction, it is possible to effectively prevent short circuiting by contact of the second current collector layer 115 with the first current collector layer 111 and first electrode active material layer 112, and to more effectively dissipate heat produced by the electrode stack. This can further improve the volumetric efficiency of the battery. In this case, at least part of the section where the second current collector layer 115 and insulating member 120 are in contact may be bonded together, and in particular the entire section may be bonded together.

The term “solid-state battery” as used herein refers to a battery using at least a solid electrolyte as the electrolyte, and the solid-state battery may employ a combination of a solid electrolyte and a liquid electrolyte as the electrolyte. The solid-state battery of the disclosure may also be an all-solid-state battery, i.e. a battery employing only a solid electrolyte as the electrolyte.

The solid-state battery of the disclosure may be a lithium ion secondary battery. Examples of battery uses include power sources for vehicles such as hybrid vehicles (HEV), plug-in hybrid vehicles (PHEV), electric vehicles (BEV), gasoline automobiles and diesel automobiles. They are most preferably used as drive power supply units for hybrid vehicles (HEV), plug-in hybrid vehicles (PHEV) or electric vehicles (BEV). The battery of the disclosure may also be used as a power source for a traveling body other than a vehicle (such as a railway car, ship or aircraft), or as a power source for an electrical product such as an information processing device.

The elements composing the solid-state battery of the disclosure will now be described.

### Electrode Stack

The solid-state battery 10 of the disclosure comprises an electrode stack 110. The electrode stack functions as a power generating element in the battery.

The electrode stack 110 has a first current collector layer 111, a first electrode active material layer 112, a solid electrolyte layer 113, a second electrode active material layer 114 and a second current collector layer 115, in that order. As exemplified in FIG. 2, the electrode stack 110 may have the first electrode active material layer 112, solid electrolyte layer 113, second electrode active material layer 114 and second current collector layer 115 in that order on both sides of the first current collector layer 111, or in other words, the electrode stack 110 may have the second current collector layer 115, second electrode active material layer 114, solid electrolyte layer 113, first electrode active material layer 112, first current collector layer 111, first electrode active material layer 112, solid electrolyte layer 113, second electrode active material layer 114 and second current collector layer 115 in that order, with one second current collector layer 115 optionally contacting the edge of the insulating member 120. FIG. 2 shows an instance with layering of two electrode stacks, each having the first electrode active material layer 112, solid electrolyte layer 113, second electrode active material layer 114 and second current collector layer 115 in that order on both sides of the first current collector layer 111, but the number of electrode stacks in the solid-state battery of the disclosure is not limited to two.

The first current collector layer may be a negative electrode collector layer, the first electrode active material layer may be a negative electrode active material layer, the second electrode active material layer may be a positive electrode active material layer and the second current collector layer may be a positive electrode collector layer. In other words, the electrode stack may have a negative electrode collector layer, negative electrode active material layer, solid electrolyte layer, positive electrode active material layer and positive electrode collector layer, in that order.

The shape of the electrode stack is not particularly restricted, and for example, it may have a top side section, a bottom side section facing the top side section, and four side sections connecting the top side section and bottom side section. The shape of the top side section is also not particularly restricted, and for example, it may be quadrilateral, such as square, rectangular, rhomboid, trapezoid or parallelogram-shaped. The shape of the top side section may also be a polygonal shape other than quadrilateral, or it may be a shape having curves, such as circular. The shape of the bottom side section may be the same shape as the top side section. The shapes of the side sections are also not particularly restricted, and for example, they may be quadrilateral, such as square, rectangular, rhomboid, trapezoid or parallelogram-shaped.

The size of the electrode stack is not particularly restricted and may be appropriately designed according to the properties desired for the battery, for example.

The constituent members of the electrode stack of the disclosure will now be described.

For convenience in explanation, each member will be described in terms of an electrode stack for a solid lithium ion secondary battery, but the solid-state battery of the disclosure is not limited to a lithium ion secondary battery.

### Positive Electrode Collector Layer

The conductive material used in the positive electrode collector layer is not particularly restricted and may be SUS, aluminum, copper, nickel, iron, titanium or carbon, for example.

The form of the positive electrode collector layer is not particularly restricted and may be, for example, a foil, sheet, mesh, porous body or the like. A foil is preferred among these.

The positive electrode collector layer may extend from the edge of the electrode stack, with a plurality of positive electrode collector layers joined at the extending part.

### Positive Electrode Active Material Layer

The positive electrode active material layer also includes at least a positive electrode active material, and it preferably further includes the solid electrolyte described below. In addition, it may include additives used in positive electrode active material layers for solid-state batteries, such as conductive aids and binders, for example, depending on the application and the purpose of use.

The material of the positive electrode active material is not particularly restricted. Examples for the positive electrode active material include heterogenous element-substituted Li—Mn spinel having a composition represented as lithium cobaltate (LiCoO₂), lithium nickelate (LiNiO₂), lithium manganate (LiMn₂O₄), Li_{1.5}Co_{1/3}Ni_{1/3}Mn_{1/3}O₂, LiCo_{1/3}Ni_{1/3}Mn_{1/3}O₂ or Li₁₊ₓMn_{2-x-y}M_{y}O₄ (where M is one or more metal elements selected from among Al, Mg, Co, Fe, Ni and Zn).

The conductive aid is not particularly restricted. For example, the conductive aid may be a carbon material such as VGCF (Vapor Grown Carbon Fibers) or carbon nanofibers, or a metal material.

The binder is also not particularly restricted. For example, the binder may be a material such as polyvinylidene fluoride (PVdF), carboxymethyl cellulose (CMC), butadiene rubber (BR) or styrene-butadiene rubber (SBR), or a combination thereof.

### Solid Electrolyte Layer

The solid electrolyte layer includes at least a solid electrolyte. The solid electrolyte used is not particularly restricted, and it may be any material that can be used as a solid electrolyte for a solid-state battery. For example, the solid electrolyte may be a sulfide solid electrolyte, an oxide solid electrolyte or a polymer electrolyte, although this is not limitative.

Examples of sulfide solid electrolytes include, but are not limited to, sulfide-based amorphous solid electrolytes, sulfide-based crystalline solid electrolytes and argyrodite solid electrolytes. Specific examples of sulfide solid electrolytes include, but are not limited to, Li₂S—P₂S₅ (Li₇P₃S₁₁, Li₃PS₄, Li₈P₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂), LiI—Li₂S—P₂O₅, LiI—Li₃PO₄—P₂S₅ and Li₇₋ₓPS₆₋ₓClₓ, as well as combinations thereof.

Examples of oxide solid electrolytes include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄ and Li₃₊ₓPO₄₋ₓNₓ(LiPON).

Polymer electrolytes include, but are not limited to, polyethylene oxide (PEO) and polypropylene oxide (PPO), and their copolymers.

The solid electrolyte may be glass or crystallized glass (glass ceramic). The solid electrolyte layer may include a conductive aid or a binder, for example, as necessary, in addition to the solid electrolyte mentioned above. The conductive aid and binder may be understood by referring to the aforementioned description regarding the positive electrode active material layer.

### Negative Electrode Active Material Layer

The negative electrode active material layer includes at least a negative electrode active material, and it preferably further includes the solid electrolyte described above. In addition, it may include additives used in negative electrode active material layers for solid-state batteries, such as conductive aids and binders, for example, depending on the application and the purpose of use.

The material for the negative electrode active material is not particularly restricted, but it is preferably one that is capable of occluding and releasing metal ions such as lithium ions. For example, the negative electrode active material may be, but is not limited to, an oxide-based negative electrode active material, alloy-based negative electrode active material or carbon material.

Oxide-based negative electrode active materials are not particularly restricted and include lithium titanate (LTO) particles.

Alloy-based negative electrode active materials are not particularly restricted, and examples include Si alloy-based negative electrode active materials and Sn alloy-based negative electrode active materials. Examples of Si alloy-based negative electrode active materials include silicon, silicon oxides, silicon carbides, silicon nitrides, and their solid solutions. A Si alloy-based negative electrode active material may also include elements other than silicon, such as Fe, Co, Sb, Bi, Pb, Ni, Cu, Zn, Ge, In, Sn and Ti, for example. Examples of Sn alloy-based negative electrode active materials include tin, tin oxides, tin nitrides, and their solid solutions. A Sn alloy-based negative electrode active material may also include elements other than tin, such as Fe, Co, Sb, Bi, Pb, Ni, Cu, Zn, Ge, In, Ti and Si, for example.

Carbon materials are not particularly restricted and include hard carbon, soft carbon and graphite, for example.

The solid electrolyte to be used in the negative electrode active material layer will be understood by referring to the aforementioned description of the solid electrolyte layer, while the conductive aid and binder will be understood by referring to the aforementioned description of the positive electrode active material layer.

### Negative Electrode Collector Layer

The conductive material used in the negative electrode collector layer is not particularly restricted and may be, but is not limited to, SUS, aluminum, copper, nickel, iron, titanium or carbon, for example.

The form of the negative electrode collector layer is not particularly restricted and may be, for example, a foil, sheet, mesh, porous body or the like. A foil is preferred among these.

The negative electrode collector layer may extend from the edge of the electrode stack, with a plurality of negative electrode collector layers joined at the extending part.

### Insulating Member

The insulating member 120 is disposed on at least part of the edge of the electrode stack 110 in the solid-state battery 10 of the disclosure.

The insulating member 120 may include a thermoplastic resin, or it may be a thermoplastic resin. Such a construction can facilitate adhesion of the second current collector layer 115 to the insulating member 120. That is, the second current collector layer 115 can be bonded by being pressed against the insulating member 120 while heating, as described below.

The thermoplastic resin is not particularly restricted and may be either a non-reactive type or reactive type. A non-reactive type thermoplastic resin is not particularly restricted, and examples include ethylene-vinyl acetate (EVA)-based, synthetic rubber, olefin-based, polyamide-based and polyester-based (such as polyethylene terephthalate (PET)) resins. A reactive type resin is also not particularly restricted, and examples include urethane-based resins.

The insulating member 120 may include a curable resin, or it may be a curable resin. The curable resin may have a tacky property after having been cured. Using such a curable resin can facilitate adhesion of the second current collector layer 115 to the insulating member 120.

A curable resin is not particularly restricted, and examples include thermosetting resins and photocuring resins. Such resins may be acrylic or epoxy resins, for example.

Using such a resin as the insulating member 120 will help facilitate placement of the insulating member 120 on the edge of the electrode stack 110.

The insulating member 120 may also be insulation tape. The insulation tape may be double-sided tape. Using such insulation tape can likewise facilitate adhesion of the second current collector layer 115 to the insulating member 120.

Using insulation tape as the insulating member 120 can reduce the space occupied by the insulating member 120, thus further improving the volumetric efficiency of the battery.

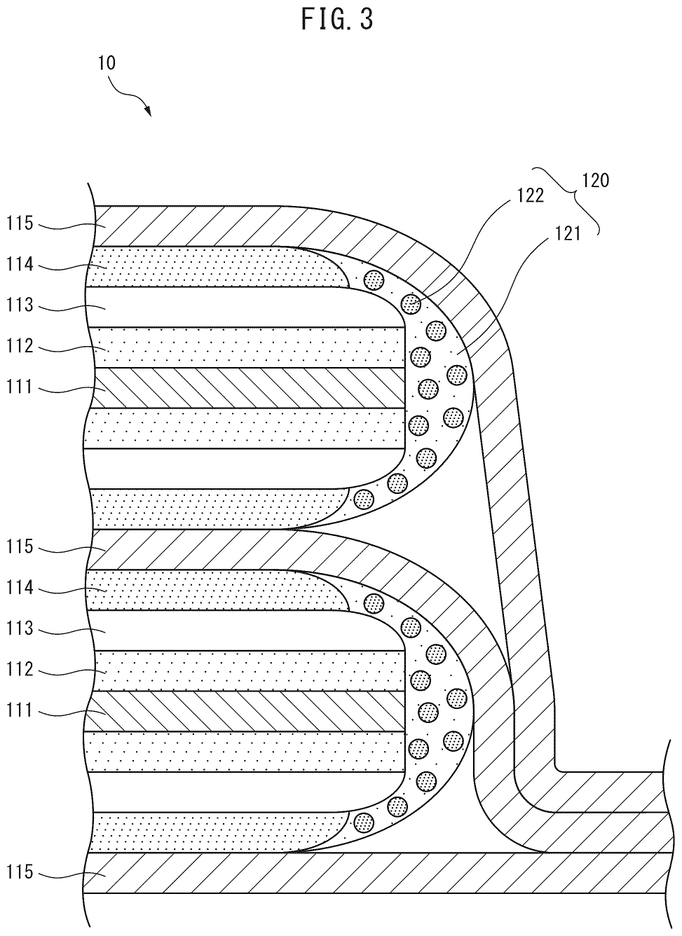

As exemplified in FIG. 3, the insulating member 120 may include a mixture of a resin 121 and an insulating filler 121, with the thermal conductivity of the insulating filler being higher than the thermal conductivity of the resin. As used herein, “insulation” means an electric resistivity of 10⁸ Ω·cm or greater. If the insulating member 120 includes an insulating filler 121, it will be possible for heat produced by the electrode stack 110 to be effectively dissipated out of the battery. FIG. 3 is a magnified simple cross-sectional view of part of the insulating member 120 of the solid-state battery 10 of the disclosure. FIG. 3 shows an instance with layering of two electrode stacks, each having the first electrode active material layer 112, solid electrolyte layer 113, second electrode active material layer 114 and second current collector layer 115 in that order on both sides of the first current collector layer 111, but the number of electrode stacks in the solid-state battery of the disclosure is not limited to two.

As mentioned above, the current collector layer of the electrode stack 110 will be particularly likely to increase in temperature. Disposing the insulating member 120 in a manner covering the first current collector layer 111 at the edge of the electrode stack 110 allows heat produced by the electrode stack 110 to be effectively dissipated.

The insulating filler may be a metal oxide. The metal oxide is not particularly restricted and may be aluminum oxide, for example.

The shape and size of the insulating member 120 is not particularly restricted, and it may be designed as appropriate in consideration of allowing easier contact of the second current collector layer, and of volumetric efficiency of the battery. For example, the length of the insulating member 120 in the stacking direction of the electrode stack 110 may be smaller than the thickness of the electrode stack 110. With this construction, even if a battery module with a solid-state battery 10 of the disclosure is formed as described below, it will be possible to prevent the insulating member 120 from interfering with constraint in the stacking direction of the electrode stack 110.

### Laminate Film

The solid-state battery 10 of the disclosure may have a laminate film 130. The laminate film may house the electrode stack. Specifically, the laminate film may house the electrode stack by winding around the electrode stack. Alternatively, the laminate film may be constructed of first and second films, in which case it may sandwich and house the electrode stack with the first and second films from above and below in the stacking direction of the electrode stack.

The laminate film may have a sealant resin layer, a metal layer and a protective resin layer, in that order along the thickness direction. Examples of materials for the sealant resin layer include olefin-based resins such as polypropylene (PP) and polyethylene (PE). Examples of materials for the metal layer include aluminum, aluminum alloy and stainless steel. Examples of materials for the protective resin layer include polyethylene terephthalate (PET) and nylon.

The thicknesses of the layers forming the laminate film and of the laminate film itself are not particularly restricted. The thickness of the sealant resin layer may be 40 μm to 100 μm, for example. The thickness of the metal layer may be 30 μm to 60 μm, for example. The thickness of the protective resin layer may be 20 μm to 60 μm, for example. The thickness of the laminate film may be 80 μm to 250 μm, for example.

### Collector Terminals

The solid-state battery 10 of the disclosure may also comprise collector terminals 140. The collector terminals may each be electrically connected to a current collector of the electrode stack. The materials of the collector terminals are not particularly restricted so long as they have a current collection function. As exemplified in FIG. 1, the positive electrode collector terminal and negative electrode collector terminal may be disposed on a pair of opposite side sections of the electrode stack. The positive electrode collector terminal and negative electrode collector terminal may be disposed apart from each other on one side section of the electrode stack.

The shapes and sizes of the collector terminals are not particularly restricted.

When the solid-state battery of the disclosure has collector terminals, the laminate film may house the electrode stack together with the collector terminals. Specifically, the laminate film may house the electrode stack together with the collector terminals by winding together the electrode stack and the collector terminals. The laminate film may also be constructed of first and second films, in which case the first and second films may sandwich the electrode stack and collector terminals from above and below in the stacking direction of the electrode stack, housing the electrode stack together with the collector terminals.

### Method for Producing Solid-State Battery

The method of the disclosure for producing a solid-state battery comprises the following steps: (a) stacking the first current collector layer 111, the first electrode active material layer 112, the solid electrolyte layer 113 and the second electrode active material layer 114 in that order to form a preliminary stack, (b) applying the insulating member 120 onto at least part of the edge of the preliminary stack, (c) stacking the second current collector layer 115 on the second electrode active material layer of the preliminary stack after application of the insulating member, to form the electrode stack, and (d) contacting the second current collector layer with the insulating member.

This method allows production of a solid-state battery of the disclosure having improved volumetric efficiency.

### Preliminary Stack-Forming Step

The method of the disclosure comprises (a) stacking the first current collector layer, first electrode active material layer, solid electrolyte layer and second electrode active material layer in that order to form a preliminary stack.

The “preliminary stack”, for the purpose of the disclosure, is a stack having a first current collector layer, first electrode active material layer, solid electrolyte layer and second electrode active material layer in that order, allowing formation of an electrode stack by further stacking of a second current collector layer.

The method of stacking the layers is not particularly restricted, and for example, it may be a method of dry molding such as compaction, or wet molding using a slurry. For wet molding, first one side of the first current collector layer is coated with a first electrode mixture slurry that is able to form a first electrode active material layer, and then dried to obtain a first electrode active material layer layered on the first current collector layer. Using a solid electrolyte slurry then allows a solid electrolyte layer to be layered in the same manner on the first electrode active material layer. By using a second electrode mixture slurry it is possible to layer a second electrode active material layer in the same manner on the solid electrolyte layer.

### Insulating Member Application Step

The method of the disclosure also comprises (b) applying an insulating member onto at least part of the edge of the preliminary stack.

The method for applying the insulating member onto at least part of the edge of the preliminary stack is not particularly restricted. For example, when the insulating member is a thermoplastic resin, the method may be one in which the molten thermoplastic resin is applied or coated by dipping onto at least part of the edge of the preliminary stack, and then solidified. When the insulating member is a curable resin, for example, the method may be one in which a curable resin is applied or coated by dipping onto at least part of the edge of the preliminary stack, and then cured. When the insulating member is insulation tape, for example, the method may be one in which the insulation tape is attached to at least part of the edge of the preliminary stack.

### Electrode Stack Forming Step

The method of the disclosure further comprises (c) stacking the second current collector layer onto the second electrode active material layer of the preliminary stack, after application of the insulating member, to form an electrode stack.

The method of stacking the second current collector layer onto the second electrode active material layer of the preliminary stack to form an electrode stack is not particularly restricted. When the second current collector layer is a metal foil, for example, the method may be one in which the metal foil is disposed on the second electrode active material layer of the preliminary stack and pressed.

### Contact Step

The method of the disclosure further comprises (d) contacting the second current collector layer with the insulating member.

When the insulating member includes a thermoplastic resin, and in step (d), the second current collector layer may be bonded by being pressed against the insulating member while heating. This allows the second current collector layer to be bonded to the insulating member by a simple method.

When the insulating member includes a curable resin with a tacky property after curing, or when it is insulation tape having a pressure-sensitive adhesion property on both sides, the second current collector layer may be pressed against the insulating member for adhesion in step (d).

The method of the disclosure may also comprise stacking the first electrode active material layer, solid electrolyte layer and second electrode active material layer in that order on both sides of the first current collector layer in step (a). In this case, the second current collector layer may be stacked on both sides of two second electrode active material layers in step (c), to form an electrode stack, and one second current collector layer may be contacted with the insulating member in step (d).

### Battery Module

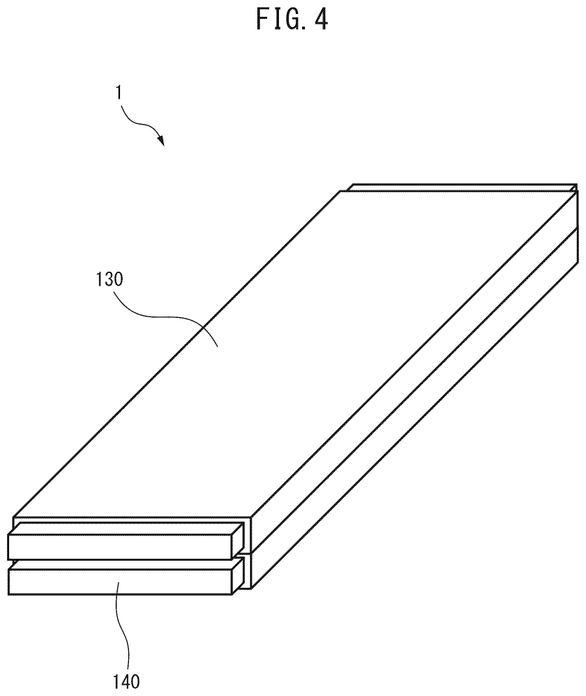

As exemplified in FIG. 4, the battery module 1 of the disclosure comprises a solid-state battery 10 of the disclosure. As mentioned above, if the length of the insulating member in the stacking direction of the electrode stack is smaller than the thickness of the electrode stack in the solid-state battery of the disclosure, then it is possible to prevent the insulating member from interfering with constraint in the stacking direction of the electrode stack in the battery module. The solid-state battery 10 of the disclosure will be understood by referring to the aforementioned description of the solid-state battery of the disclosure.

The number of solid-state batteries of the disclosure in the battery module of the disclosure is not particularly restricted, but it is at least one. All of the batteries in the battery module of the disclosure may be solid-state batteries of the disclosure. FIG. 4 shows a case where the number of solid-state batteries is 2, but the number of solid-state batteries in the battery module of the disclosure is not limited to 2.

### Solid-State Battery

As exemplified in FIG. 1, the solid-state battery 10 of the disclosure comprises an electrode stack 110. As exemplified in FIG. 3, the electrode stack 110 has a first current collector layer 111, a first electrode active material layer 112, a solid electrolyte layer 113, a second electrode active material layer 114 and a second current collector layer 115 in that order, the insulating member 120 being disposed on at least the edge of the electrode stack 110, the insulating member 120 including a mixture of a resin 121 and an insulating filler 122, and the thermal conductivity of the insulating filler 122 is greater than the thermal conductivity of the resin 121.

As mentioned above, in a battery comprising an electrode stack, the electrode stack often releases heat during charge-discharge, with the current collector layer of the electrode stack in precursor tending to increase in temperature. The present inventors have found that if an insulating member disposed on the edge of an electrode stack includes a mixture of a resin and an insulating filler having higher thermal conductivity than the resin, then heat produced by the electrode stack can be dissipated out of the battery through the insulating member.

In the solid-state battery 10 of the disclosure, the second current collector layer 115 may extend from the electrode stack 110. In this case, the second current collector layer 115 may contact with the insulating member 120, and in particular the second current collector layer 115 may be in bonded contact with the insulating member 120. With such a construction it is possible for heat produced by the electrode stack 110 to be dissipated out of the battery through the insulating member 120 and the second current collector 115.

### REFERENCE SIGNS LIST

1 Battery module
10 Solid-state battery
110 Electrode stack
111 First current collector layer
112 First electrode active material layer
113 Solid electrolyte layer
114 Second electrode active material layer
115 Second current collector layer
120 Insulating member
130 Laminate film
140 Collector terminal

1. A solid-state battery comprising an electrode stack, wherein:
the electrode stack has a first current collector layer, a first electrode active material layer, a solid electrolyte layer, a second electrode active material layer and a second current collector layer, in that order,
an insulating member is disposed on at least part of the edge of the electrode stack,
the second current collector layer extends from the edge of the electrode stack on which the insulating member is disposed, and
the second current collector layer is contacted with the insulating member.

2. The solid-state battery according to claim 1, wherein:
the electrode stack has the first electrode active material layer, the solid electrolyte layer, the second electrode active material layer and the second current collector layer in that order on both sides of the first current collector layer, and
the one second current collector layer is contacted with the insulating member.

3. The solid-state battery according to claim 2, wherein:
the insulating member is disposed at the edge of the electrode stack, from the one second electrode active material layer across to the other second electrode active material layer, and
the second current collector layer is contacted with the insulating member over 50% or more of the surface area of the insulating member.

4. The solid-state battery according to claim 1, wherein the insulating member includes a thermoplastic resin.

5. The solid-state battery according to claim 1, wherein the insulating member includes a mixture of a resin and an insulating filler, and the thermal conductivity of the insulating filler is greater than the thermal conductivity of the resin.

6. The solid-state battery according to claim 5, wherein the insulating filler is a metal oxide.

7. The solid-state battery according to claim 1, wherein the first current collector layer is a negative electrode collector layer, the first electrode active material layer is a negative electrode active material layer, the second electrode active material layer is a positive electrode active material layer and the second current collector layer is a positive electrode collector layer.

8. A battery module comprising a solid-state battery according to claim 7.

9. A method for producing a solid-state battery according to claim 1, the method comprising the following steps:
(a) stacking the first current collector layer, the first electrode active material layer, the solid electrolyte layer and the second electrode active material layer in that order to form a preliminary stack,
(b) applying the insulating member onto at least part of the edge of the preliminary stack,
(c) stacking the second current collector layer on the second electrode active material layer of the preliminary stack after application of the insulating member, to form the electrode stack, and
(d) contacting the second current collector layer with the insulating member.

10. The method according to claim 9, wherein:
the insulating member includes a thermoplastic resin, and
in step (d), the second current collector layer is bonded by being pressed against the insulating member while heating.

11. A solid-state battery comprising an electrode stack, wherein:
the electrode stack has a first current collector layer, a first electrode active material layer, a solid electrolyte layer, a second electrode active material layer and a second current collector layer, in that order,
an insulating member is disposed on at least part of the edge of the electrode stack,
the insulating member includes a mixture of a resin and an insulating filler, and
the thermal conductivity of the insulating filler is greater than the thermal conductivity of the resin.
